(19) United States
(12) Patent Application Publication
(10) Pub. No.: US 2002/0049879 A1
(43) Pub. Date: Apr. 25, 2002

(54) Cable and connection with integrated DVI and IEEE 1394 capabilities

(75) Inventor: Mark K. Eyer, San Diego, CA (US)

Correspondence Address: HAVERSTOCK & OWENS LLP, 162 NORTH WOLFE ROAD, SUNNYVALE, CA, 94086, US

(73) Assignee: Sony Corporation and Sony Electronics, Inc.

(21) Appl. No.: 09/904,973

(22) Filed: Jul. 12, 2001

Related U.S. Application Data
(60) Provisional application No. 60/242,380, filed on Oct. 20, 2000.

(51) Int. Cl. G06F 13/00; G06F 13/42

(52) U.S. Cl. 710/305; 710/100; 710/105

(57) ABSTRACT

A cable and connection with integrated DVI and IEEE 1394-2000 capabilities is utilized to transmit DVI signals and IEEE 1394-2000 signals over a single cable. A standard DVI cable and a DVI connector are used to integrate a DVI interface with an IEEE 1394-2000 interface. In the preferred embodiment, DVI data is transmitted over the first TMDS link, including channels 0-2, and IEEE 1394-2000 data is transmitted over two twisted pairs within the second TMDS link, including channels 3-5. Preferably, a DVI connector routes the DVI signals to or from the DVI digital signal lines corresponding to the first TMDS link to a DVI receiver circuit or a DVI transmitter circuit, as appropriate, and routes IEEE 1394-2000 signals to or from the DVI digital signal lines corresponding to the second TMDS link to an IEEE 1394-2000 interface circuit. Each connector at either end of the DVI cable then is in communication with either a DVI transmitter circuit or a DVI receiver circuit, as appropriate, to communicate the DVI video signals, and also with an IEEE 1394-2000 physical interface circuit to communicate the IEEE 1394-2000 signals.

### RELATED APPLICATIONS

This application claims priority under 35 U.S.C. § 119(e) of the co-pending U.S. provisional application Serial No. 60/242,380 filed on Oct. 19, 2000 and entitled “DVI WITH INTEGRATED IEEE 1394.” The provisional application Serial No. 60/242,380 filed on Oct. 19, 2000 and entitled “DVI WITH INTEGRATED IEEE 1394” is also hereby incorporated by reference.

### FIELD OF THE INVENTION

The present invention relates to the field of network cabling and connections between devices. More particularly, the present invention relates to the field of network cabling and connections for use between devices operating according to the IEEE 1394 serial bus protocol and the DVI protocol.

### BACKGROUND OF THE INVENTION

The IEEE standard, “IEEE 1394-2000 Standard For A High Performance Serial Bus,” Draft ratified in 2000, is an international standard for implementing an inexpensive high-speed serial bus architecture which supports both asynchronous and isochronous format data transfers. Isochronous data transfers are real-time transfers which take place such that the time intervals between significant instances have the same duration at both the transmitting and receiving applications. Each packet of data transferred isochronously is transferred in its own time period. The IEEE 1394-2000 standard bus architecture provides up to sixty-four (64) channels for isochronous data transfer between applications. A six bit channel number is broadcast with the data to ensure reception by the appropriate application. This allows multiple applications to simultaneously transmit isochronous data across the bus structure. Asynchronous transfers are traditional data transfer operations which take place as soon as possible and transfer an amount of data from a source to a destination.

The IEEE 1394-2000 standard provides a high-speed serial bus for interconnecting digital devices thereby providing a universal I/O connection. The IEEE 1394-2000 standard defines a digital interface for the applications thereby eliminating the need for an application to convert digital data to analog data before it is transmitted across the bus. Correspondingly, a receiving application will receive digital data from the bus, not analog data, and will therefore not be required to convert analog data to digital data. The cable required by the IEEE 1394-2000 standard is very thin in size compared to other bulkier cables used to connect such devices. Devices can be added and removed from an IEEE 1394-2000 bus while the bus is active. If a device is so added or removed the bus will then automatically reconfigure itself for transmitting data between the then existing nodes. A node is considered a logical entity with a unique identification number on the bus structure. Each node provides an identification ROM, a standardized set of control registers and its own address space.

The IEEE 1394-2000 standard defines a protocol as illustrated in FIG. 1. This protocol includes a serial bus management block 10 coupled to a transaction layer 12, a link layer 14 and a physical layer 16. The physical layer 16 provides the electrical and mechanical connection between a device or application and the IEEE 1394-2000 cable. The physical layer 16 also provides arbitration to ensure that all devices coupled to the IEEE 1394-2000 bus have access to the bus as well as actual data transmission and reception. The link layer 14 provides data packet delivery service for both asynchronous and isochronous data packet transport. This supports both asynchronous data transport, using an acknowledgement protocol, and isochronous data transport, providing real-time guaranteed bandwidth protocol for just-in-time data delivery. The transaction layer 12 supports the commands necessary to complete asynchronous data transfers, including read, write and lock. The serial bus management block 10 contains an isochronous resource manager for managing isochronous data transfers. The serial bus management block 10 also provides overall configuration control of the serial bus in the form of optimizing arbitration timing, guarantee of adequate electrical power for all devices on the bus, assignment of the cycle master, assignment of isochronous channel and bandwidth resources and basic notification of errors.

A standard IEEE 1394-2000 cable is illustrated in FIG. 2A. An IEEE 1394-2000 network using the standard IEEE 1394-2000 cable 20 is a differential, copper wire network, which includes two differential pairs of wires 22 and 24, carrying the differential signals TPA and TPB, respectively. As shown in FIG. 2A, the pairs of wires 22 and 24 are twisted together within the cable 20. The signals TPA and TPB are both low voltage, low current, bidirectional differential signals used to carry data bits or arbitration signals. The signals TPA and TPB have a maximum specified amplitude of 265 m Volts. The twisted pairs of wires 22 and 24 have a relatively high impedance, specified at 110 ohms, such that minimal power is needed to drive an adequate signal across the wires 22 and 24. The standard IEEE 1394-2000 cable 20 also includes a pair of power signals VG and VP, carried on the wires 26 and 28, respectively. The wires 26 and 28 are also twisted together within the cable 20. The pair of power signals VP and VG provide the current needed by the physical layer of the serial bus to repeat signals. The wires 26 and 28 have a relatively low impedance and are specified to have a maximum power level of 60 watts.

The IEEE 1394-2000 standard also provides for a four-pin cable as illustrated in FIG. 2B. The four-pin cable 20′ includes the two differential pairs of wires 22 and 24 which carry the differential signals TPA and TPB, respectively. The four-pin cable 20′ does not include the power and ground wires 26 and 28.

The IEEE 1394-2000 cable environment is a network of nodes connected by point-to-point links, including a port on each node's physical connection and the cable between them. The physical topology for the cable environment of an IEEE 1394-2000 serial bus is a non-cyclic network of multiple ports, with finite branches. The primary restriction on the cable environment is that nodes must be connected together without forming any closed loops.

The IEEE 1394-2000 cable connects ports together on different nodes. Each port includes terminators, transceivers and simple logic. A node can have multiple ports at its physical connection. The cable and ports act as bus repeaters between the nodes to simulate a single logical bus.

The Digital Visual Interface specification (hereinafter DVI) promoted by the Digital Display Working Group (hereinafter DDWG) provides a high-speed digital connection for visual data types that is display technology independent. The DVI interface is primarily focused at providing a connection between a computer and its display device. The DVI interface is a plug and play interface and provides for hot plug detection and monitor feature detection.

The DVI interface utilizes a transition minimized differential signaling (TMDS) protocol and encoding algorithm. The DVI interface uses TMDS for the base electrical connection. The TMDS link is used to send graphics data to the monitor. The transition minimization is achieved by implementing an advanced encoding algorithm that converts 8 bits of data into a 10-bit transition minimized, DC balanced character.

The DVI interface specification allows for two TMDS links enabling large pixel format digital display devices. One or two TMDS links are available depending on the pixel format and timings desired. The two TMDS links share the same clock allowing the bandwidth to be evenly divided between the two links. As the capabilities of the monitor are determined the system will choose to enable one or both of the TMDS links.

A block diagram showing the logical links between a transmitting device and a receiving device over a DVI interface is illustrated in FIG. 3. A graphics controller 30 within the transmitting device sends pixel data and control data to a TMDS transmitter 32. The TMDS transmitter 32 then sends data over the DVI interface 38 to a TMDS receiver 34. The TMDS receiver 34 then provides pixel data and control data to a display controller 36 within the receiving device.

A TMDS transmitter 32 encodes and serially transmits an input data stream over a TMDS link to a TMDS receiver 34. The input stream contains pixel and control data. The DVI interface or TMDS link 38 is a parallel connection between the TMDS transmitter 32 and the TMDS receiver 34. The TMDS transmitter 32 contains three identical encoders, each driving one serial TMDS data channel. The input to each encoder is two control signals and eight bits of pixel data. The transmitter encodes either pixel data or control data on any given input clock cycle, depending on the state of the data enable signal. Depending on the state of the data enable signal, the encoder will produce 10-bit TMDS characters from either the two control signals or from the eight bits of pixel data. The output of each decoder is a continuous stream of serialized TMDS characters. The TMDS clock channel carries a character-rate frequency reference from which the receiver produces a bit-rate sample clock for the incoming serial streams.

The number of data channels in the TMDS link architecture was originally chosen based on the combination of bandwidth required for video data and the logical simplicity of using one data channel each for red, green and blue pixel data. The dual TMDS link identified within the DVI specification uses six data channels sharing a single clock channel to double the bandwidth of the interface. For this dual TMDS link configuration, the first data link transmits odd pixels while the second data link transmits even pixels. The first pixel of each line is pixel number one, an odd pixel.

DVI compliant host systems may provide either a digital only interface or a combined analog and digital interface. The system-side connector distinguishes the system capabilities. The two defined connectors have the same physical outer dimensions. In each case the digital signals are present, allowing a monitor with a digital interface to attach directly to either system connector. Because the digital only receptacle does not have sockets for the analog pins of an analog monitor, the plug of an analog monitor will not mate with the digital only system.

A front view of a digital only receptacle connector is illustrated in FIG. 4a. A front view of a combined analog and digital receptacle connector is illustrated in FIG. 4b. A side view of the connectors of FIGS. 4a and 4b is illustrated in FIG. 4c. Because the two defined connectors have the same physical outer dimensions, the side view of the connectors 40 and 46 is the same.

The digital only receptacle connector 40 of FIG. 4a includes 24 digital connector pins 42 denoted as digital pins 1-24. The TMDS differential data channel 2 signal is included within the connector 40 at digital pins 1 and 2. The TMDS differential data channel 4 signal is included within the connector 40 at digital pins 4 and 5. A TMDS data shield shared by the data channels 2 and 4 is included within the connector 40 at digital pin 3. The TMDS differential data channel 1 signal is included within the connector 40 at digital pins 9 and 10. The TMDS differential data channel 3 signal is included within the connector 40 at digital pins 12 and 13. A TMDS data shield shared by the data channels 1 and 3 is included within the connector 40 at digital pin 11. The TMDS differential data channel 0 signal is included within the connector 40 at digital pins 17 and 18. The TMDS differential data channel 5 signal is included within the connector at digital pins 20 and 21. A TMDS data shield shared by the data channels 0 and 5 is included within the connector 40 at digital pin 19.

A DDC clock signal is included within the connector 40 at digital pin 6. A DDC data signal is included within the connector 40 at digital pin 7. A 5 V power signal is included within the connector 40 at digital pin 14. A ground signal is included within the connector 40 at digital pin 15. The TMDS differential clock signal is included within the connector 40 at digital pins 23 and 24. A TMDS clock shield signal is included within the connector 40 at digital pin 22. A hot plug detect signal is included within the connector 40 at digital pin 16. An analog vertical synchronization signal is included within the connector 40 at digital pin 8.

The combined analog and digital receptacle connector 46 of FIG. 4b includes 24 digital connector pins 42 denoted as digital pins 1-24 and 5 analog connector pins 44 denoted as analog pins C1-C5. The digital connector pins 42 include the signals as described above with respect to the digital only connector 40. An analog red signal is included within the connector 46 at analog pin C1. An analog green signal is included within the connector 46 at analog pin C2. An analog blue signal is included within the connector 46 at analog pin C3. An analog horizontal synchronization signal is included within the connector 46 at analog pin C4. An analog ground signal is included within the connector 46 at analog pin C5.

It is being contemplated within some standards bodies to adapt the DVI standard for digital television applications. The DVI standard currently lacks any support for audio, either compressed or uncompressed. The DVI standard also does not include or provide the ability for the display device to output an audio/video transport stream through the DVI connection and ability for other audio/video devices in an audio/video device network to have access to the digital television for discovery purposes or to send compressed MPEG data.

A block diagram of a settop box and a digital television coupled together with an interface according to the DVI standard and a separate audio connection, is illustrated in FIG. 5. The settop box 50 is coupled to receive signals from a source device, such as a satellite dish 102. The satellite dish 102 is coupled to a tuner/demodulator circuit 54 within the settop box 50. The tuner/demodulator circuit 54 is coupled to an MPEG-2 demultiplexer circuit 52, which demultiplexes the audio and video signals received from the satellite dish 102. The MPEG-2 demultiplexer circuit 52 is then coupled to an MPEG-2 decoder circuit 56 and to an IEEE 1394-2000 interface circuit 66. The IEEE 1394-2000 interface circuit 66 is coupled to a port 68 for sending and receiving signals over an IEEE 1394-2000 serial bus, when connected. The MPEG-2 decoder circuit 56 decodes the video portion of the signal received from the satellite dish 102. The output of the MPEG-2 decoder circuit 56 is coupled to an input of a multiplexer circuit 60. An output from a graphics circuit 58 is coupled to an input of the multiplexer circuit 60. The multiplexer circuit 60 then multiplexes the video signals from the MPEG-2 decoder circuit 56 and the signals from the graphics circuit 58 and provides these multiplexed signals to a DVI transmitter circuit 62. The DVI transmitter circuit 62 is then coupled to a DVI connector 64 for transmitting video signals to the digital television 80. The MPEG-2 demultiplexer circuit 52 is also coupled to an audio decoder circuit 70 for transmitting the audio portion of the signal received from the satellite dish 102, to the audio decoder circuit 70. The audio decoder circuit 70 decodes the audio portion of the signal received from the satellite dish 102. The output of the audio decoder circuit 70 is coupled to an audio connector 72.

The digital television includes a DVI connector 82 and an audio connector 86. A DVI cable 100 is coupled between the DVI connector 64 of the settop box 50 and the DVI connector 82 of the digital television 80 for transmitting DVI video data across the DVI interface from the settop box 50 to the digital television 80. The audio connector 72 is coupled to the audio connector 86 by an audio cable 104 for transmitting audio signals from the settop box 50 to the digital television 80.

The DVI connector 82 of the digital television 80 is coupled to a DVI receiver circuit 84. The DVI receiver circuit 84 is coupled to a display 92 for sending video data to be displayed by the digital television 80. An antenna 98 is coupled to a terrestrial tuner/demodulator circuit 88 for receiving other broadcast television signals. The terrestrial tuner/demodulator circuit 88 is coupled to an MPEG-2 decoder circuit 90. The MPEG-2 decoder circuit 90 then separates the video and audio signals from the broadcast transmission. The MPEG-2 decoder circuit 90 provides the video signals to the display 92 and the audio signals to an audio switch 94. The audio connector 86 is also coupled to provide audio signals from the settop box 50 to the audio switch 94. The audio switch 94 then provides a selective one of the audio signal inputs, as appropriate, to be output by a speaker 96.

When using the DVI interface standard for application to a digital television, the audio signals available at the source, such as the settop box 50, must be delivered to a receiver, such as the digital television 80, by cables separate from the DVI cable 100. Also, the digital television 80 may have a cable or terrestrial broadcast tuner/demodulator 88, and hence be able to act as a source device for other receiving devices. A digital path to provide these signals from the digital television 80 to other devices is desirable. Adding these additional data paths to the system is possible using current technology, but requires additional cabling and connectors.

### SUMMARY OF THE INVENTION

A cable and connection with integrated DVI and IEEE 1394-2000 capabilities is utilized to transmit DVI signals and IEEE 1394-2000 signals over a single cable. A standard DVI cable and a DVI connector are used to integrate a DVI interface with an IEEE 1394-2000 interface. In the preferred embodiment, DVI data is transmitted over the first TMDS link, including channels 0-2, and IEEE 1394-2000 data is transmitted over two twisted pairs within the second TMDS link, including channels 3-5. Preferably, a DVI connector routes the DVI signals to or from the DVI digital signal lines corresponding to the first TMDS link to a DVI receiver circuit or a DVI transmitter circuit, as appropriate, and routes IEEE 1394-2000 signals to or from the DVI digital signal lines corresponding to the second TMDS link to an IEEE 1394-2000 interface circuit. Each connector at either end of the DVI cable then is in communication with either a DVI transmitter circuit or a DVI receiver circuit, as appropriate, to communicate the DVI video signals, and also with an IEEE 1394-2000 physical interface circuit to communicate the IEEE 1394-2000 signals.

In one aspect of the present invention, a DVI connector for receiving and transmitting DVI signals and IEEE 1394 signals over a DVI cable comprises means for receiving and transmitting the DVI signals configured for coupling to the DVI cable for transmitting and receiving the DVI signals and means for receiving and transmitting the IEEE 1394 signals configured for coupling to the DVI cable for transmitting and receiving the IEEE 1394 signals. The means for receiving and transmitting the DVI signals includes a plurality of digital pins corresponding to a first link. The plurality of digital pins preferably includes twenty-four pins. The means for receiving and transmitting the IEEE 1394 signals preferably includes a plurality of digital pins corresponding to a second link. The plurality of digital pins preferably includes four pins and carries two differential signal pairs. The plurality of digital pins communicate digital signals substantially according to the IEEE 1394 standard. The means for receiving and transmitting the DVI signals is further configured for coupling to a selective one of a DVI transmitter circuit and a DVI receiver circuit for transmitting and receiving the DVI signals. The DVI signals from the DVI transmitter circuit are transmitted over the DVI cable to a receiving device. The DVI signals received from the DVI cable are provided to the DVI receiver circuit. DVI data transmitted using the DVI signals and IEEE 1394 data transmitted using the IEEE 1394 signals are synchronized for output at a receiving device. The means for receiving and transmitting the IEEE 1394 signals is further configured for coupling to an IEEE 1394 interface circuit. The DVI connector further comprises the DVI cable coupled to the means for receiving and transmitting the DVI signals and to the means for receiving and transmitting the IEEE 1394 signals. The IEEE 1394 signals include isochronous and asynchronous data.

In another aspect of the present invention, a DVI connector to receive and transmit DVI signals and IEEE 1394 signals over a DVI cable comprises a first plurality of pins configured to couple to the DVI cable to transmit and receive the DVI signals and a second plurality of pins configured to couple to the DVI cable to transmit and receive the IEEE 1394 signals. The first plurality of pins are further configured to couple to a selective one of a DVI transmitter circuit and a DVI receiver circuit to transmit and receive the DVI signals. The DVI signals from the DVI transmitter circuit are transmitted over the DVI cable to a receiving device. The DVI signals received from the DVI cable are provided to the DVI receiver circuit. DVI data transmitted using the DVI signals and IEEE 1394 data transmitted using the IEEE 1394 signals are synchronized for output at a receiving device. The second plurality of pins are further configured to couple to an IEEE 1394 interface circuit. The DVI connector further comprises the DVI cable coupled to the first plurality of pins and to the second plurality of pins. The second plurality of pins communicate digital signals substantially according to the IEEE 1394 standard. The IEEE 1394 signals include isochronous and asynchronous data.

In yet another aspect of the present invention, a DVI connector for receiving and transmitting IEEE 1394 signals over a DVI cable comprising a plurality of pins configured for coupling to the DVI cable for transmitting and receiving the IEEE 1394 signals, wherein the plurality of pins are further configured for coupling to an IEEE 1394 interface circuit. The plurality of pins preferably are digital pins within a DVI connector. The plurality of digital pins communicate digital signals substantially according to the IEEE 1394 standard. The DVI connector further comprises the DVI cable coupled to the plurality of pins. The plurality of pins preferably includes four pins and carries two differential signal pairs.

In still yet another aspect of the present invention, a method of receiving and transmitting DVI signals and IEEE 1394 signals over a DVI cable comprises communicating the DVI signals over the DVI cable and communicating the IEEE 1394 signals over the DVI cable. The DVI signals are communicated over a plurality of digital pins in a connector and a plurality of digital signal lines within the DVI cable. The IEEE 1394 signals are preferably communicated over a plurality of digital pins in a connector and a plurality of digital signal lines within the DVI cable. The plurality of digital pins communicate digital signals substantially according to the IEEE 1394 standard. The method further comprises synchronizing DVI data transmitted using the DVI signals and IEEE 1394 data transmitted using the IEEE 1394 signals for output at a receiving device.

In yet another aspect of the present invention, a communication device for transmitting and receiving signals with other devices including a DVI connector for receiving and transmitting DVI signals and IEEE 1394 signals over a DVI cable, the DVI connector comprises a first plurality of pins configured for coupling to the DVI cable for transmitting and receiving the DVI signals and a second plurality of pins configured for coupling to the DVI cable for transmitting and receiving the IEEE 1394 signals. The first plurality of pins are further configured for coupling to a selective one of a DVI transmitter circuit and a DVI receiver circuit for transmitting and receiving the DVI signals. The DVI signals from the DVI transmitter circuit are transmitted over the DVI cable to a receiving device. The DVI signals received from the DVI cable are provided to the DVI receiver circuit. DVI data transmitted using the DVI signals and IEEE 1394 data transmitted using the IEEE 1394 signals are synchronized for output at a receiving device. The second plurality of pins are further configured for coupling to an IEEE 1394 interface circuit. The communication device further comprises the DVI cable coupled to the first plurality of pins and to the second plurality of pins. The second plurality of pins communicate digital signals substantially according to the IEEE 1394 standard.

In still yet another aspect of the present invention, a network of devices comprises a DVI cable including digital signal lines with a first plurality of the digital signal lines corresponding to a first link and a second plurality of the digital signal lines corresponding to a second link, a source device including a DVI transmitter circuit configured for transmitting DVI signals, a first IEEE 1394 interface circuit for communicating IEEE 1394 signals and a first DVI connector coupled to the DVI cable for transmitting DVI signals and transmitting and receiving the IEEE 1394 signals, the first DVI connector including a first plurality of digital pins coupled to the first plurality of digital signal lines of the DVI cable and to the DVI transmitter circuit for transmitting the DVI signals and a second plurality of digital pins coupled to the second plurality of digital signal lines of the DVI cable and to the first IEEE 1394 interface circuit for transmitting and receiving the IEEE 1394 signals and a receiving device including a DVI receiver circuit configured for receiving the DVI signals, a second IEEE 1394 interface circuit for communicating the IEEE 1394 signals and a second DVI connector coupled to the DVI cable for receiving DVI signals and transmitting and receiving the IEEE 1394 signals, the second DVI connector including a third plurality of digital pins coupled to the first plurality of digital signal lines of the DVI cable and to the DVI receiver circuit for receiving the DVI signals and a fourth plurality of digital pins coupled to the second plurality of digital signal lines of the DVI cable and to the second IEEE 1394 interface circuit for transmitting and receiving the IEEE 1394 signals. DVI data transmitted using the DVI signals and IEEE 1394 data transmitted using the IEEE 1394 signals are synchronized for output at the receiving device.

### BRIEF DESCRIPTION OF THE DRAWINGS

FIG. 1 illustrates a protocol of the IEEE 1394-2000 standard.

FIG. 2A illustrates a standard IEEE 1394-2000 six-pin cable.

FIG. 2B illustrates a standard IEEE 1394-2000 four-pin cable.

FIG. 3 illustrates a block diagram showing the logical links between a transmitting device and a receiving device over an interface according to the DVI standard.

FIG. 4a illustrates a front view of a digital only receptacle connector for a DVI interface.

FIG. 4b illustrates a front view of a combined analog and digital receptacle connector for a DVI interface.

FIG. 4c illustrates a side view of the connectors of FIGS. 4a and 4b.

FIG. 5 illustrates a block diagram of a settop box and a digital television coupled together with an interface according to the DVI standard and a separate audio connection.

FIG. 6 illustrates a block diagram of a settop box and a digital television coupled together by a DVI cable and DVI connectors according to the present invention.

FIG. 7a illustrates a front view of the DVI connector of the preferred embodiment of the present invention.

FIG. 7b illustrates a front view of the DVI connector of an alternative embodiment of the present invention.

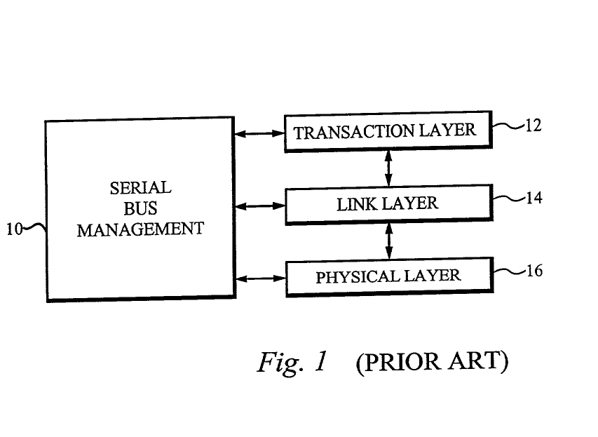

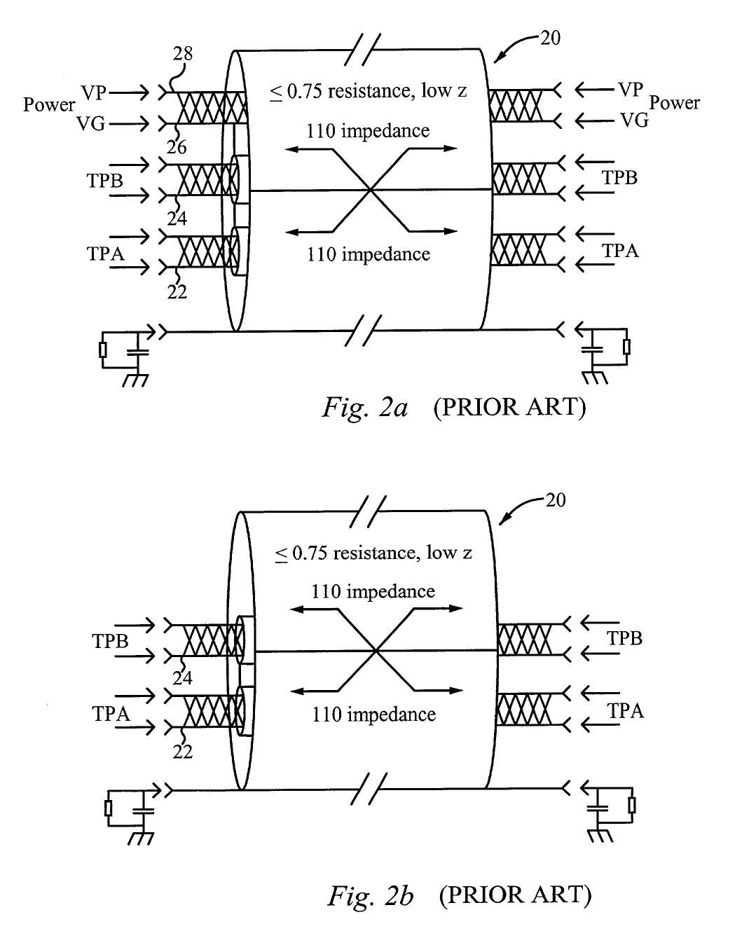

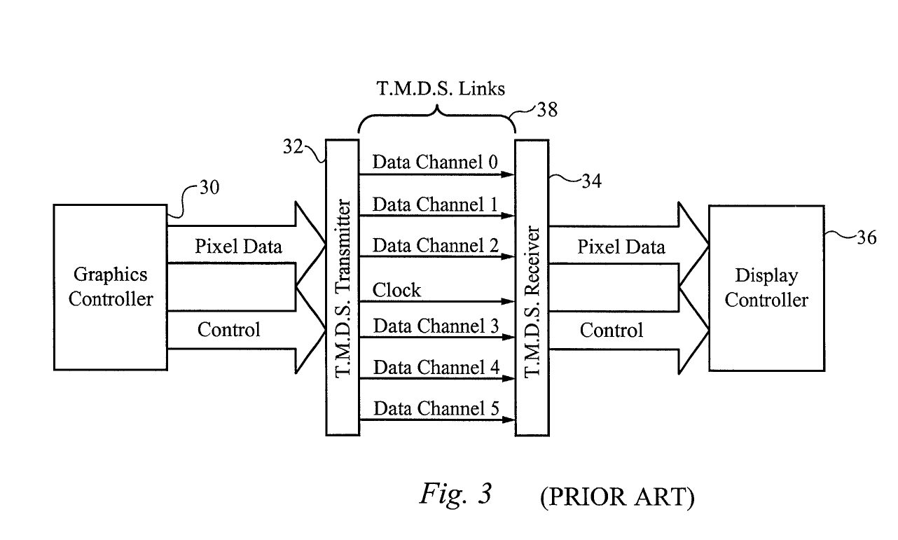

### DETAILED DESCRIPTION OF THE PREFERRED EMBODIMENT

A connection of the present invention utilizes a standard DVI cable and a DVI connector to integrate a DVI interface between a source device and a display device with an IEEE 1394-2000 interface. Preferably, the DVI cable is not modified. Over a standard DVI cable, the DVI video data is transmitted using the DVI digital signal lines, as described above, and data is also transmitted according to the IEEE 1394-2000 standard over the DVI cable. In the preferred embodiment, DVI data is transmitted over the first TMDS link, including channels 0-2, and the IEEE 1394-2000 data is transmitted over two twisted pairs within the second TMDS link, including channels 3-5. The second TMDS link includes three pairs of digital signal lines within the channels 3-5. The IEEE 1394-2000 differential signals TPA and TPB are included on any combination of two of the three available pairs of signal lines within the second TMDS link. Preferably, a DVI connector routes the DVI signals, to or from the DVI digital signal lines corresponding to the first TMDS link, to a DVI receiver circuit or a DVI transmitter circuit, as appropriate, and routes IEEE 1394-2000 signals to or from the DVI digital signal lines, corresponding to the second TMDS link, to an IEEE 1394-2000 interface circuit. In this preferred embodiment, either the DVI digital only connector or the DVI combined digital and analog connector are utilized at either end of the DVI cable.

As should be apparent to those skilled in the art, alternatively, the DVI signals are transmitted over the DVI digital signal lines corresponding to the second link and the channels 3-5. In further alternate embodiments, the IEEE 1394-2000 signals are transmitted over any appropriate and available signal lines within the DVI cable which are capable of transmitting the IEEE 1394-2000 differential signals TPA and TPB.

Utilizing the DVI cable and connector to include IEEE 1394-2000 signal lines, as described above, allows any type of appropriate data to be sent over the IEEE 1394-2000 signal lines between devices within an IEEE 1394-2000 serial bus network. This also allows audio signals to be sent over the IEEE 1394-2000 signal lines while corresponding video signals are sent over the DVI digital connections. This also allows the display device to send signals back to the source device or to other devices coupled within the IEEE 1394-2000 serial bus network. Each DVI connector at either end of the DVI cable then is in communication with either a DVI transmitter circuit or a DVI receiver circuit, as appropriate, to communicate the DVI video signals, and also with an IEEE 1394-2000 physical interface circuit to communicate the IEEE 1394-2000 signals.

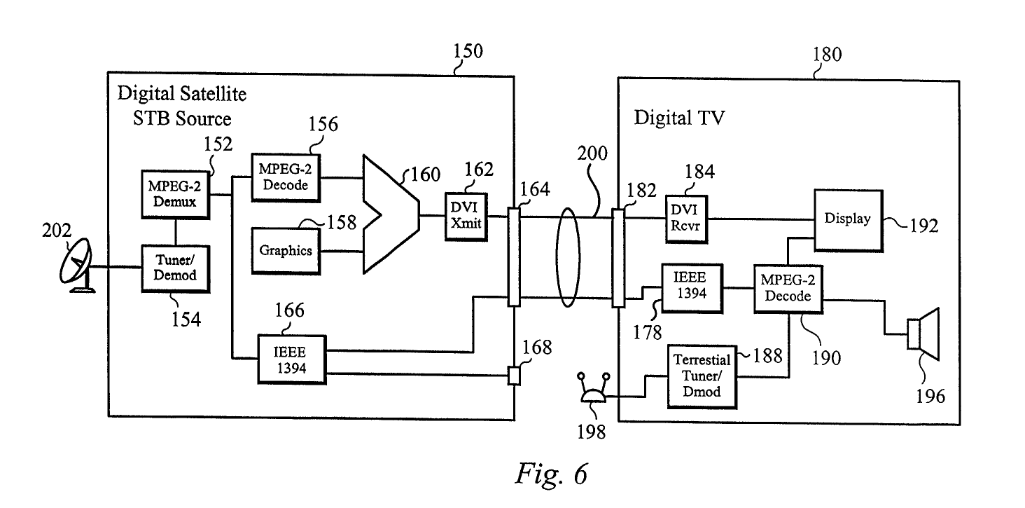

A block diagram of a settop box and a digital television coupled together by a DVI cable and DVI connectors according to the present invention is illustrated in FIG. 6. The settop box 150 is coupled to receive signals from a source device, such as a satellite dish 202. The satellite dish 202 is coupled to a tuner/demodulator circuit 154 within the settop box 150. The tuner/demodulator circuit 154 is coupled to an MPEG-2 demultiplexer circuit 152, which demultiplexes the audio and video signals received from the satellite dish 202. The MPEG-2 demultiplexer circuit 152 is then coupled to an MPEG-2 decoder circuit 156 and to an IEEE 1394-2000 interface circuit 166, to provide the demultiplexed video signals to the MPEG-2 decoder circuit 156 and the demultiplexed video and audio signals to the IEEE 1394-2000 interface circuit 166, as will be discussed below. The IEEE 1394-2000 interface circuit 166 is coupled to a DVI connector 164 of the present invention for sending and receiving signals over the DVI cable 200, including the audio signals received from the MPEG-2 demultiplexer circuit 152, to the digital television 180. The IEEE 1394-2000 interface circuit 166 is also coupled to an IEEE 1394-2000 port 168 for sending and receiving signals over an IEEE 1394-2000 serial bus, to other devices within an IEEE 1394-2000 serial bus network, when connected.

The MPEG-2 decoder circuit 156 decodes the video portion of the signal received from the satellite dish 202. The output of the MPEG-2 decoder circuit 156 is coupled to an input of a multiplexer circuit 160. An output from a graphics circuit 158 is coupled to an input of the multiplexer circuit 160. The multiplexer circuit 160 then multiplexes the video signals from the MPEG-2 decoder circuit 156 and the signals from the graphics circuit 158 and provides these multiplexed signals to a DVI transmitter circuit 162. The DVI transmitter circuit 162 is then coupled to the connector 164 for transmitting the video signals over the DVI cable 200 to the digital television 180.

The digital television 180 includes a DVI connector 182 according to the present invention. A DVI cable 200 is coupled between the DVI connector 164 of the settop box 150 and the DVI connector 182 of the digital television 180 for transmitting both DVI signals and IEEE 1394-2000 signals, as described herein. The DVI signals are transmitted from the settop box 150 to the digital television 180. The IEEE 1394-2000 signals can be transmitted in either direction between the settop box 150 and the digital television 180.

The DVI connector 182 of the digital television 180 is coupled to provide the DVI signals from the DVI cable 200 to the DVI receiver circuit 184. The DVI receiver circuit 184 is coupled to a display 192 for sending video signals to be displayed by the digital television 180. The DVI connector 182 of the digital television 180 is coupled to the IEEE 1394-2000 interface circuit 178 for communicating the IEEE 1394-2000 signals between the IEEE 1394-2000 interface circuit 178 and the DVI cable 200.

An antenna 198 is coupled to a terrestrial tuner/demodulator circuit 188 for receiving other broadcast television signals. The terrestrial tuner/demodulator circuit 188 is coupled to an MPEG-2 decoder circuit 190. The IEEE 1394-2000 interface circuit 178 is also coupled to the MPEG-2 decoder circuit 190. The MPEG-2 decoder circuit 190 then separates the video and audio signals from the terrestrial tuner/demodulator circuit 188 and/or the IEEE 1394-2000 interface circuit 178. The MPEG-2 decoder circuit 190 then provides the video signals to the display 192 and the audio signals to a speaker 196, to be output as appropriate. The terrestrial tuner/demodulator circuit 188 is also coupled to the IEEE 1394-2000 interface circuit 178 to provide the signals from the antenna 198 to other devices over the IEEE 1394-2000 serial bus network.

The cable 200 of the present invention is preferably, an unmodified DVI cable, as described above and specified within the DVI standard. Preferably, the DVI digital signal lines within the DVI cable 200 are utilized to transmit the DVI signals and the IEEE 1394-2000 signals, as described herein.

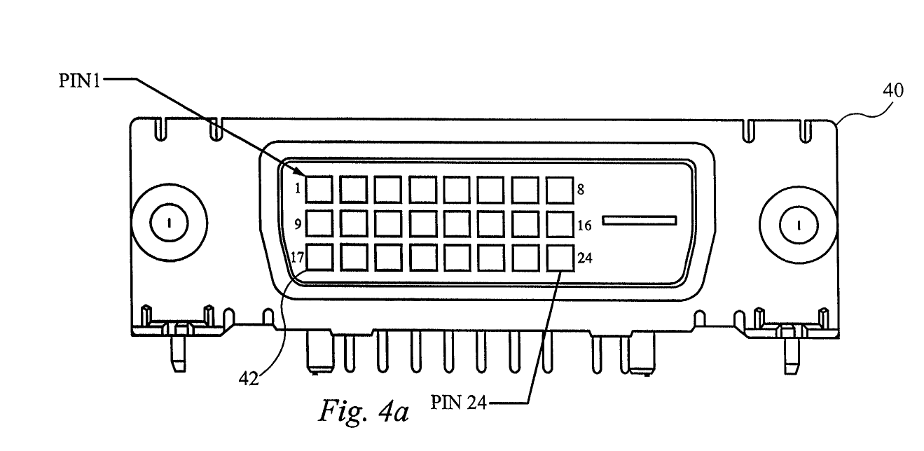

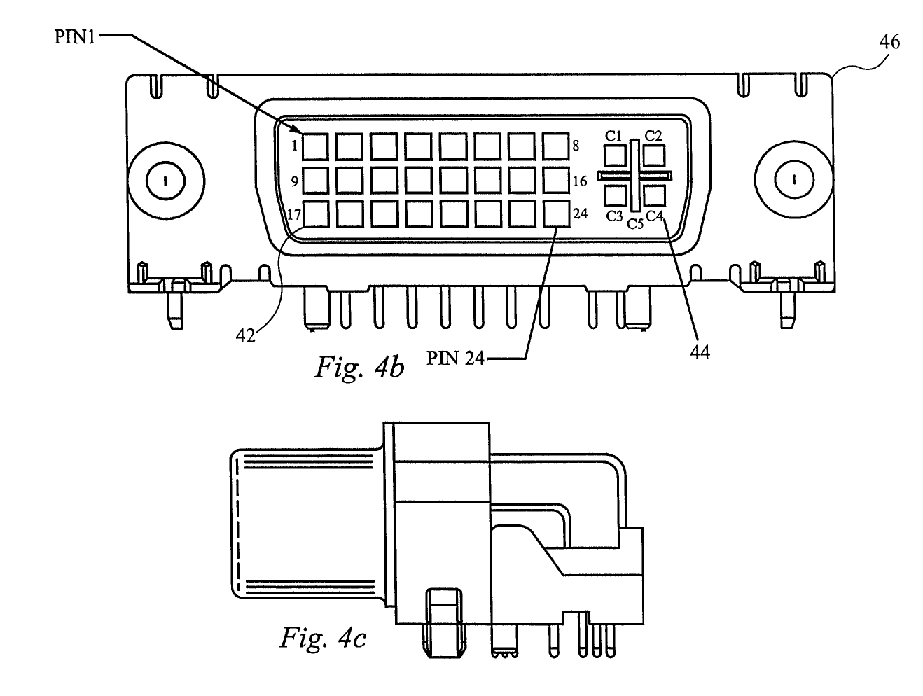

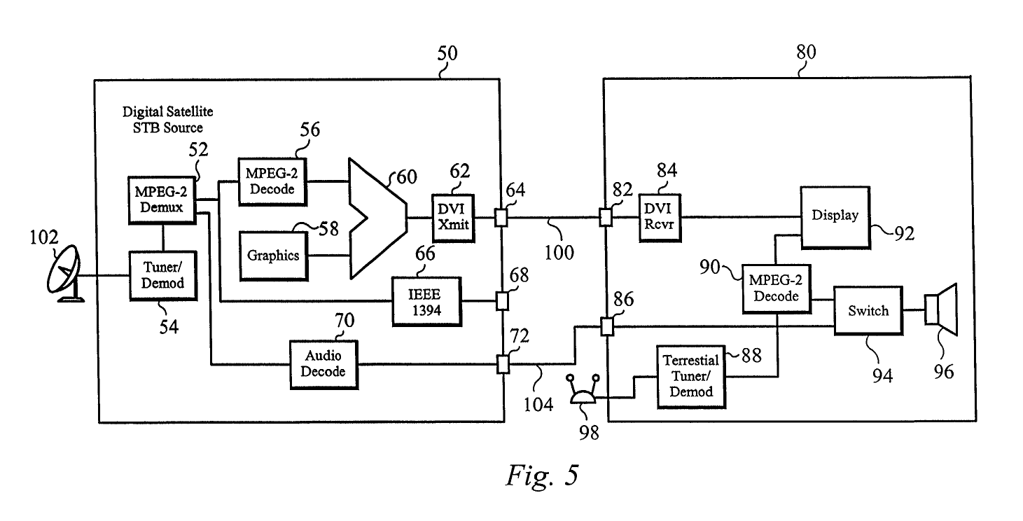

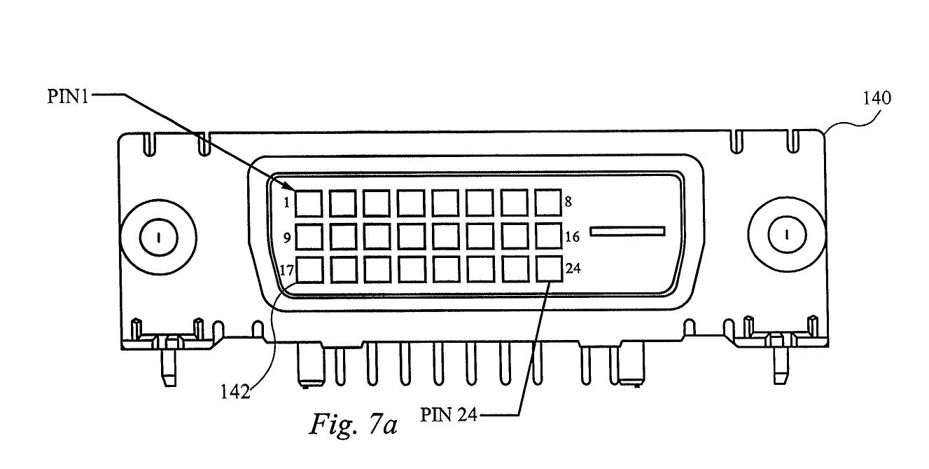

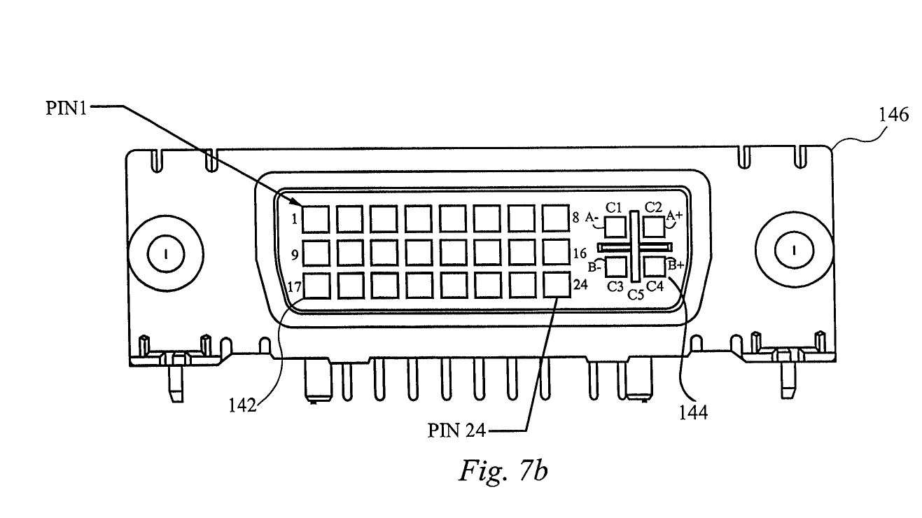

A front view of the digital only DVI connector of the present invention is illustrated in FIG. 7a. A front view of the combined digital and analog DVI connector of the present invention is illustrated in FIG. 7b. The DVI connectors 140 and 146 include 24 digital connector pins 142. Preferably, the DVI signals are included within the digital connector pins 142, corresponding to the first TMDS link and the channels 0-2, as described above with respect to the connector 40 of FIG. 4a. The IEEE 1394-2000 signals are preferably included within the connectors 140 and 146 within the digital connector pins 142 corresponding to the second TMDS link and the channels 3-5. The second TMDS link includes three pairs of digital signal lines corresponding to the channels 3-5. As described above, the TMDS differential data channels 3-5 are included within the connectors 140 and 146 at the pins 12 and 13, the pins 4 and 5 and the pins 20 and 21, respectively. The IEEE 1394-2000 differential signals TPA and TPB are included on any combination of two of the three available pairs of signal lines within the second TMDS link. The appropriate pairs of pins within the connectors 140 and 146, utilized for the IEEE 1394-2000 differential pairs A and B are then coupled to provide these IEEE 1394-2000 signals to an IEEE 1394-2000 interface circuit. For the preferred embodiment, either the digital only connector 140 or the combined digital and analog connector 146 can be used, because the IEEE 1394-2000 signals are included within the digital signal lines which are included in both the digital only connector and the combined digital and analog connector.

As discussed above, the six-pin cable described within the IEEE 1394-2000 specification utilizes wires within the cable to carry the power signals VP and VG. The four-pin cable described in the IEEE 1394-2000 specification does not include wires to carry the power signals VP and VG. In the preferred embodiment of the present invention, the cable 200 does not include any DC power conductors. Within the preferred embodiment of the present invention, DC power is provided separately to the devices within the IEEE 1394-2000 network, outside of the cable 200. The DC power is preferably provided locally by each active device. Alternatively, the DC power is provided by a separate power cable.

To display a broadcast transmission from the satellite 202 on the digital television 180, the digital television 180 must receive the broadcast transmission from the satellite 202 through the settop box 150. The broadcast transmission is received by the satellite 202 and transmitted to the tuner/demodulator circuit 154. The tuner/demodulator circuit 154 then provides the broadcast transmission to the MPEG-2 demultiplexer circuit 152. The MPEG-2 demultiplexer circuit 152 then demultiplexes the broadcast transmission and separates the video data from the audio data. The separated video data is provided to the MPEG-2 decoder circuit 156, which decodes the video data and provides it to the multiplexer 160. The multiplexer 160 then provides the video data to the DVI transmitter circuit 162 which transmits the video data through the DVI connector 164 and onto the DVI cable 200 using the DVI digital signal lines according to the DVI standard, as described above.

The separated audio data from the MPEG-2 demultiplexer circuit 152 is provided to the IEEE 1394-2000 interface circuit 166. The separated video data from the MPEG-2 demultiplexer circuit 152 is also provided to the IEEE 1394-2000 interface circuit 166 for synchronization purposes, as will be discussed below. The separated audio data is then transmitted through the DVI connector 164 and onto the DVI cable 200 preferably using the DVI digital signal lines corresponding to the second TMDS link and channels 3-5, as IEEE 1394-2000 signal lines, as described above. The audio data is preferably transmitted from the settop box 150 to the digital television 180 over the IEEE 1394-2000 signal lines (DVI digital signal lines corresponding to the second TMDS link and channels 3-5) as an elementary stream component within an MPEG-2 transport stream. Alternatively, the audio data is transmitted from the settop box 150 to the digital television 180 over the IEEE 1394-2000 signal lines in any appropriate manner, including any of the methods described in the IEC 61883-6 standard, Audio and Music Data Transmission Protocol, which is hereby incorporated by reference. Transmitting the audio data as an MPEG-2 transport stream has the benefit that presentation timing is handled by the MPEG PCR/PTS timing mechanism. When the audio data is transmitted as an MPEG-2 transport stream, the audio data is carried on the IEEE 1394-2000 signal lines in accordance with the IEC 61883-4 standard, which is also hereby incorporated by reference. The elementary stream can carry compressed audio data in accordance with ATSC A/53 Annex B (Dolby Digital [AC-3]), MPEG-1 or MPEG-2 formats. The elementary stream can also carry uncompressed audio data.

At the digital television 180, the video data and the audio data carried over the DVI cable 200 are received at the DVI connector 182. The DVI connector 182 preferably receives the video data on the DVI digital signal lines corresponding to the first TMDS link and channels 0-2 and provides those signals to the DVI receiver circuit 184. The DVI receiver circuit 184 then provides the video data received on the DVI digital signal lines to the display 192 for displaying the video data. The DVI connector 182 preferably receives the audio data transmitted according to the IEEE 1394-2000 serial bus standard on the DVI digital signal lines corresponding to the second TMDS link and the channels 3-5. The audio data received according to the IEEE 1394-2000 serial bus standard on the DVI digital signal lines corresponding to the second TMDS link and the channels 3-5 is provided from the DVI connector 182 to the IEEE 1394-2000 interface circuit 178. The audio data is then provided from the IEEE 1394-2000 interface circuit 178 to the MPEG-2 decoder circuit 190, where the audio data is decoded and then provided to be output by the speaker 196.

When output by the digital television 180 the video data and audio data are preferably synchronized to each other. The audio data transmitted over the IEEE 1394-2000 signal lines is preferably synchronized to the video data, as described above, using the MPEG PCR/PTS timing mechanism. Alternatively, in order to synchronize the output of the audio data to the display of the video data, at the digital television 180, both the video data and audio data are transmitted by the IEEE 1394-2000 interface circuit 166 through the DVI connector 164 and over the DVI cable 200. In this embodiment, the DVI video data is also sent from the DVI transmitter circuit 162 through the DVI connector 164 and over the DVI cable 200. Because the video data is decoded within the settop box 150 there is no time reference information within the stream of DVI video data. At the digital television 180, the video and audio data received on the IEEE 1394-2000 signal lines (DVI digital signal lines corresponding to the second TMDS link and channels 3-5) is then provided to the IEEE 1394-2000 interface circuit 178. The IEEE 1394-2000 interface circuit 178 obtains the time stamps from the video data and then discards this video data. The IEEE 1394-2000 interface circuit 178 then outputs the audio data to correspond to the appropriate time stamps obtained from the video data. In this manner, the audio data is output by the digital television 180 to be synchronized with the display of the DVI video data on the display 192.

In a further alternative embodiment, only a partial transport stream of video data is transmitted over the IEEE 1394-2000 signal lines with the audio data. In this embodiment, only the portions of the video data necessary to obtain the time reference data are transmitted with the audio data. This time reference data is then used to synchronize the output of the audio data by the digital television 180 with the display of the DVI video data.

Data can also be sent from the digital television 180 through the DVI connector 182 and over the IEEE 1394-2000 signal lines of the DVI cable 200 to the settop box 150. This data can include isochronous and asynchronous data. The data sent from the digital television 180 can be transmitted just to the settop box 150 or can be transmitted through the settop box 150 to any other device within the IEEE 1394-2000 serial bus network.

It should also be apparent to those skilled in the art that any appropriate type of data can be sent between the settop box 150 and the digital television 180 over the IEEE 1394-2000 signal lines through the DVI connectors 164 and 182 of the present invention, including both isochronous and asynchronous data, as described herein. The IEEE 1394-2000 signal lines of the DVI cable 200 are utilized as an IEEE 1394-2000 serial bus cable to carry the IEEE 1394-2000 signals TPA and TPB, as described herein. The IEEE 1394-2000 interface circuits 166 and 178, transmit and receive the data to and from the DVI cable 200, as if it were received from a standard IEEE 1394-2000 serial bus cable. Utilizing the DVI cable 200 and the DVI connectors 164 and 182, a single cable and corresponding connectors are used to carry both DVI signals and IEEE 1394-2000 signals. The IEEE 1394-2000 signal lines can be used to transmit data over the IEEE 1394-2000 serial bus between the digital television 18 and the settop box 150.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is used to communicate data according to an IEEE 1394-2000 standard, the present invention could also be implemented according to other appropriate standards, including other versions of the IEEE 1394 standard. It will also be apparent to those skilled in the art that while the preferred embodiment of the present invention includes the DVI connectors and cables described herein, the present invention alternatively includes any other appropriate DVI connector and cable to transmit and receive the DVI signals and the IEEE 1394-2000 signals.

I claim:

1. A DVI connector for receiving and transmitting DVI signals and IEEE 1394 signals over a DVI cable comprising:
a. means for receiving and transmitting the DVI signals configured for coupling to the DVI cable for transmitting and receiving the DVI signals; and
b. means for receiving and transmitting the IEEE 1394 signals configured for coupling to the DVI cable for transmitting and receiving the IEEE 1394 signals.

2. The DVI connector as claimed in claim 1 wherein the means for receiving and transmitting the DVI signals includes a plurality of digital pins corresponding to a first link.

3. The DVI connector as claimed in claim 2 wherein the plurality of digital pins includes twenty-four pins.

4. The DVI connector as claimed in claim 1 wherein the means for receiving and transmitting the IEEE 1394 signals includes a plurality of digital pins corresponding to a second link.

5. The DVI connector as claimed in claim 4 wherein the plurality of digital pins includes four pins and carries two differential signal pairs.

6. The DVI connector as claimed in claim 4 wherein the plurality of digital pins communicate digital signals substantially according to the IEEE 1394 standard.

7. The DVI connector as claimed in claim 1 wherein the means for receiving and transmitting the DVI signals is further configured for coupling to a selective one of a DVI transmitter circuit and a DVI receiver circuit for transmitting and receiving the DVI signals.

8. The DVI connector as claimed in claim 7 wherein the DVI signals from the DVI transmitter circuit are transmitted over the DVI cable to a receiving device.

9. The DVI connector as claimed in claim 7 wherein the DVI signals received from the DVI cable are provided to the DVI receiver circuit.

10. The DVI connector as claimed in claim 1 wherein DVI data transmitted using the DVI signals and IEEE 1394 data transmitted using the IEEE 1394 signals are synchronized for output at a receiving device.

11. The DVI connector as claimed in claim 1 wherein the means for receiving and transmitting the IEEE 1394 signals is further configured for coupling to an IEEE 1394 interface circuit.

12. The DVI connector as claimed in claim 1 further comprising the DVI cable coupled to the means for receiving and transmitting the DVI signals and to the means for receiving and transmitting the IEEE 1394 signals.

13. The DVI connector as claimed in claim 1 wherein the IEEE 1394 signals include isochronous and asynchronous data.

14. A DVI connector configured to receive and transmit DVI signals and IEEE 1394 signals over a DVI cable comprising:
a. a first plurality of pins configured to couple to the DVI cable to transmit and receive the DVI signals; and
b. a second plurality of pins configured to couple to the DVI cable to transmit and receive the IEEE 1394 signals.

15. The DVI connector as claimed in claim 14 wherein the first plurality of pins are further configured to couple to a selective one of a DVI transmitter circuit and a DVI receiver circuit to transmit and receive the DVI signals.

16. The DVI connector as claimed in claim 15 wherein the DVI signals from the DVI transmitter circuit are transmitted over the DVI cable to a receiving device.

17. The DVI connector as claimed in claim 15 wherein the DVI signals received from the DVI cable are provided to the DVI receiver circuit.

18. The DVI connector as claimed in claim 14 wherein DVI data transmitted using the DVI signals and IEEE 1394 data transmitted using the IEEE 1394 signals are synchronized for output at a receiving device.

19. The DVI connector as claimed in claim 14 wherein the second plurality of pins are further configured to couple to an IEEE 1394 interface circuit.

20. The DVI connector as claimed in claim 14 further comprising the DVI cable coupled to the first plurality of pins and to the second plurality of pins.

21. The DVI connector as claimed in claim 14 wherein the second plurality of pins communicate digital signals substantially according to the IEEE 1394 standard.

22. The DVI connector as claimed in claim 14 wherein the IEEE 1394 signals include isochronous and asynchronous data.

23. A DVI connector for receiving and transmitting IEEE 1394 signals over a DVI cable comprising a plurality of pins configured for coupling to the DVI cable for transmitting and receiving the IEEE 1394 signals, wherein the plurality of pins are further configured for coupling to an IEEE 1394 interface circuit.

24. The DVI connector as claimed in claim 23 wherein the plurality of pins are digital pins within a DVI connector.

25. The DVI connector as claimed in claim 24 wherein the plurality of digital pins communicate digital signals substantially according to the IEEE 1394 standard.

26. The DVI connector as claimed in claim 23 further comprising the DVI cable coupled to the plurality of pins.

27. The DVI connector as claimed in claim 23 wherein the plurality of pins includes four pins and carries two differential signal pairs.

28. A method of receiving and transmitting DVI signals and IEEE 1394 signals over a DVI cable comprising:
a. communicating the DVI signals over the DVI cable; and
b. communicating the IEEE 1394 signals over the DVI cable.

29. The method as claimed in claim 28 wherein the DVI signals are communicated over a plurality of digital pins in a connector and a plurality of digital signal lines within the DVI cable.

30. The method as claimed in claim 28 wherein the IEEE 1394 signals are communicated over a plurality of digital pins in a connector and a plurality of digital signal lines within the DVI cable.

31. The method as claimed in claim 30 wherein the plurality of digital pins communicate digital signals substantially according to the IEEE 1394 standard.

32. The method as claimed in claim 28 further comprising synchronizing DVI data transmitted using the DVI signals and IEEE 1394 data transmitted using the IEEE 1394 signals for output at a receiving device.

33. A communication device for transmitting and receiving signals with other devices including a DVI connector for receiving and transmitting DVI signals and IEEE 1394 signals over a DVI cable, the DVI connector comprising:
a. a first plurality of pins configured for coupling to the DVI cable for transmitting and receiving the DVI signals; and
b. a second plurality of pins configured for coupling to the DVI cable for transmitting and receiving the IEEE 1394 signals.

34. The communication device as claimed in claim 33 wherein the first plurality of pins are further configured for coupling to a selective one of a DVI transmitter circuit and a DVI receiver circuit for transmitting and receiving the DVI signals.

35. The communication device as claimed in claim 34 wherein the DVI signals from the DVI transmitter circuit are transmitted over the DVI cable to a receiving device.

36. The communication device as claimed in claim 34 wherein the DVI signals received from the DVI cable are provided to the DVI receiver circuit.

37. The communication device as claimed in claim 33 wherein DVI data transmitted using the DVI signals and IEEE 1394 data transmitted using the IEEE 1394 signals are synchronized for output at a receiving device.

38. The communication device as claimed in claim 33 wherein the second plurality of pins are further configured for coupling to an IEEE 1394 interface circuit.

39. The communication device as claimed in claim 33 further comprising the DVI cable coupled to the first plurality of pins and to the second plurality of pins.

40. The communication device as claimed in claim 33 wherein the second plurality of pins communicate digital signals substantially according to the IEEE 1394 standard.

41. A network of devices comprising:
a. a DVI cable including digital signal lines with a first plurality of the digital signal lines corresponding to a first link and a second plurality of the digital signal lines corresponding to a second link;
b. a source device including:
i. a DVI transmitter circuit configured for transmitting DVI signals;
ii. a first IEEE 1394 interface circuit for communicating IEEE 1394 signals; and
iii. a first DVI connector coupled to the DVI cable for transmitting the DVI signals and transmitting and receiving the IEEE 1394 signals, the first DVI connector including:
A. a first plurality of digital pins coupled to the first plurality of digital signal lines of the DVI cable and to the DVI transmitter circuit for transmitting the DVI signals; and
B. a second plurality of digital pins coupled to the second plurality of digital signal lines of the DVI cable and to the first IEEE 1394 interface circuit for transmitting and receiving the IEEE 1394 signals; and c. a receiving device including:
i. a DVI receiver circuit configured for receiving the DVI signals;
ii. a second IEEE 1394 interface circuit for communicating the IEEE 1394 signals; and
iii. a second DVI connector coupled to the DVI cable for receiving DVI signals and transmitting and receiving the IEEE 1394 signals, the second DVI connector including:
A. a third plurality of digital pins coupled to the first plurality of digital signal lines of the DVI cable and to the DVI receiver circuit for receiving the DVI signals; and
B. a fourth plurality of digital pins coupled to the second plurality of digital signal lines of the DVI cable and to the second IEEE 1394 interface circuit for transmitting and receiving the IEEE 1394 signals.

42. The network of devices as claimed in claim 41 wherein DVI data transmitted using the DVI signals and IEEE 1394 data transmitted using the IEEE 1394 signals are synchronized for output at the receiving device.
